(19) United States
(12) Patent Application Publication
(10) Pub. No.: US 2021/0216874 A1
(43) Pub. Date: Jul. 15, 2021

(54) RADIOACTIVE DATA GENERATION

(71) Applicant: Facebook Technologies, LLC, Menlo Park, CA (US)

(72) Inventors: Hervé JEGOU, Paris (FR); Alexandre SABLAYROLLES, Paris (FR); Matthys DOUZE, Montreuil (FR)

(21) Appl. No.: 16/831,248

(22) Filed: Mar. 26, 2020

Related U.S. Application Data
(60) Provisional application No. 62/959,427, filed on Jan. 10, 2020.

(51) Int. Cl. G06N 3/08; G06N 3/04

(52) U.S. Cl. CPC G06N 3/084; G06N 3/04

(57) ABSTRACT

Disclosed herein are a system, a method and a device for radioactive data generation. A defined marker can be applied or inserted within data of at least one class of a dataset having a plurality of classes of data. The defined marker data can be used to determine if a neural network model was trained using the respective class of data. A device can determine characteristics of a neural network model. The device can compare the characteristics of the neural network model with characteristics of the defined marker data incorporated into a first class of data. The device can determine, responsive to the comparing, whether the neural network model was trained using a dataset having a plurality of classes of data that includes the first class of data incorporated with the defined marker data.

### CROSS-REFERENCE TO RELATED APPLICATION

This application claims priority to U.S. Provisional Patent Application No. 62/959,427, filed Jan. 10, 2020, which is incorporated by reference in its entirety for all purposes.

### FIELD OF DISCLOSURE

The present disclosure is generally related to computation in neural networks, including but not limited to systems and methods for radioactive data generation.

### BACKGROUND

Artificial intelligence (AI) processing can receive a plurality of datasets from multiple different originators, for example, to perform machine learning using large-scale public datasets that include data retrieved from multiple sources without, necessarily, knowing which source (e.g., originator) provided which portion of the dataset. Therefore, issues or questions regarding privacy and protection of intellectual property can arise for the originators of the respective data. For example, once a dataset is released or provided into a large-scale dataset having a plurality of datasets, it can be difficult for an originator to identify, control or restrict access to the originator's respective dataset.

### SUMMARY

Devices, systems and methods for radioactive data generation are provided herein. A device can apply a defined marker (e.g., radioactive marker) to data within a dataset such that the defined marker modifies characteristics of a neural network model trained on the respective dataset. The modified characteristics of the neural network can be used to inform and/or notify an originator of the dataset that their respective dataset has been processed by the neural network model (e.g., during training of the neural network). In some embodiments, a device can execute or perform one or more of a marking stage, a training stage, and/or a detection stage, to identify if a neural network has processed a particular dataset. In a marking stage, the device can insert or apply a defined marker to at least one class of data of a dataset. The class of data can include or correspond to a portion (e.g., less than all) of the full dataset. In a training stage, the device can provide data to a neural network to train the respective neural network. The dataset can include the marked data and/or unmarked data. In some embodiments, the device can train the neural network by using the marked data and/or unmarked data and a learning algorithm to train a classifier vector of the neural network. In a detection stage, the device can determine if the marked data was used to train the neural network. For example, the device can receive or obtain characteristics of the neural network and/or outputs from the neural network, and can compare the characteristics to characteristics of the defined marker (e.g., direction vector). The device, responsive to the comparison, can determine if the neural network was trained using the marked data or unmarked data based in part on a similarity score between the characteristics of the neural network and the characteristics of the defined marker.

In at least one aspect, a method is provided. The method can include determining, by at least one processor, characteristics of a neural network model. The method can include comparing, by the at least one processor, the characteristics of the neural network model with characteristics of a defined marker data incorporated into a first class of data. The method can include determining, by the at least one processor responsive to the comparing, whether the neural network model was trained using a dataset having a plurality of classes of data that includes the first class of data incorporated with the defined marker data.

In some embodiments, the method can include incorporating the defined marker data into data of the first class of data. The characteristics of the neural network model can include a classifier vector of the neural network model, and the characteristics of the defined marker data can include a direction vector of the defined marker data. The method can include determining a cosine similarity between the classifier vector and the direction vector.

In some embodiments, the characteristics of the neural network model can include a first loss value from applying first data without the defined marker data to the neural network model, and the characteristics of the defined marker data can include a second loss value from applying second data incorporated with the defined marker data to the neural network model. The method can include determining, responsive to the first loss value being higher than the second loss value, that the neural network model was trained using the dataset having the plurality of classes of data that includes the first class of data incorporated with the defined marker data. The defined marker data can include a random isotropic unit vector applied to data in the first class of data. The dataset can include at least one of image data, audio data or video data. The first class of data can include a continuous signal.

In at least one aspect, a method is provided. The method can include determining a classifier vector of a neural network model. The method can include determining a cosine similarity between the classifier vector and a direction vector of a defined marker data. The method can include determining, according to the cosine similarity, whether the neural network model was trained using a dataset having a plurality of classes of data that includes a first class of data that incorporates the defined marker data.

In some embodiments, the method can include determining a first loss value for the neural network from applying first data without the defined marker data to the neural network model and determining a second loss value for the defined marker from applying second data incorporated with the defined marker data to the neural network model. The method can include determining, responsive to the first loss value being higher than the second loss value, that the neural network model was trained using the dataset having the plurality of classes of data that includes the first class of data incorporated with the defined marker data. The defined marker data can include a random isotropic unit vector applied to data in the first class of data.

In at least one aspect, a device is provided. The device can include at least one processor. The at least one processor can be configured to determine characteristics of a neural network model. The at least one processor can be configured to compare the characteristics of the neural network model with characteristics of a defined marker data incorporated into a first class of data. The at least one processor can be configured to determine, responsive to the comparing, whether the neural network model was trained using a dataset having a plurality of classes of data that includes the first class of data incorporated with the defined marker data.

In some embodiments, the at least one processor can be configured to incorporate the defined marker data into data of the first class of data. The characteristics of the neural network model can include a classifier vector of the neural network model, and the characteristics of the defined marker data can include a direction vector of the defined marker data. The at least one processor can be configured to determine a cosine similarity between the classifier vector and the direction vector.

In some embodiments, the characteristics of the neural network model can include a first loss value from applying first data without the defined marker data to the neural network model, and the characteristics of the defined marker data can include a second loss value from applying second data incorporated with the defined marker data to the neural network model. The at least one processor can be configured to determine, responsive to the first loss value being higher than the second loss value, that the neural network model was trained using the dataset having the plurality of classes of data that includes the first class of data incorporated with the defined marker data. The defined marker data includes a random isotropic unit vector applied to data in the first class of data.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1A is a block diagram of an embodiment of a system for performing artificial intelligence (AI) related processing, according to an example implementation of the present disclosure.

FIG. 1B is a block diagrams of an embodiment of a device for performing AI) related processing, according to an example implementation of the present disclosure.

FIG. 1C is a block diagram of an embodiment of a device for performing AI related processing, according to an example implementation of the present disclosure.

FIG. 1D is a block diagram of a computing environment according to an example implementation of the present disclosure.

FIG. 2 is a block diagram of an embodiment of a system for radioactive data generation, according to an example implementation of the present disclosure.

FIGS. 3A-3B include a flow chart illustrating a process or method for radioactive data generation, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

For purposes of reading the description of the various embodiments of the present invention below, the following descriptions of the sections of the specification and their respective contents may be helpful:
Section A describes embodiments of devices, systems and methods for artificial intelligence related processing.
Section B describes embodiments of devices, systems and methods for radioactive data generation.

### A. Environment for Artificial Intelligence Related Processing

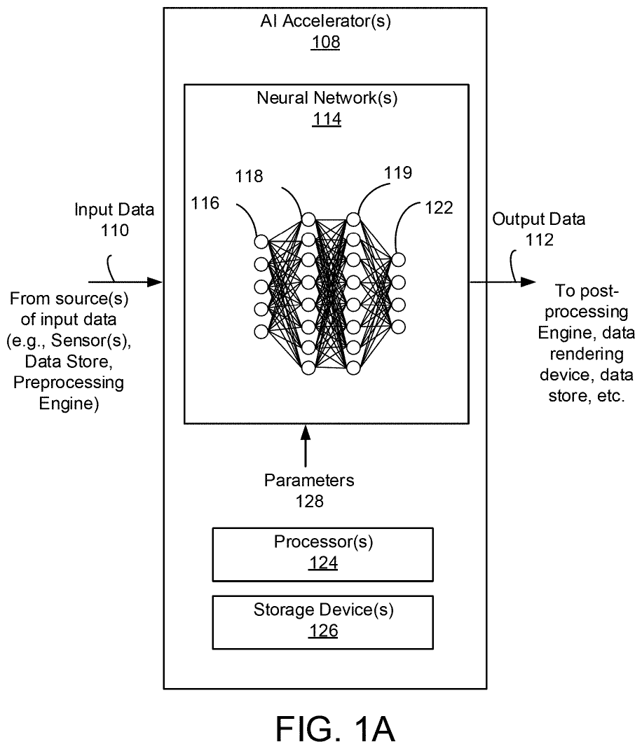

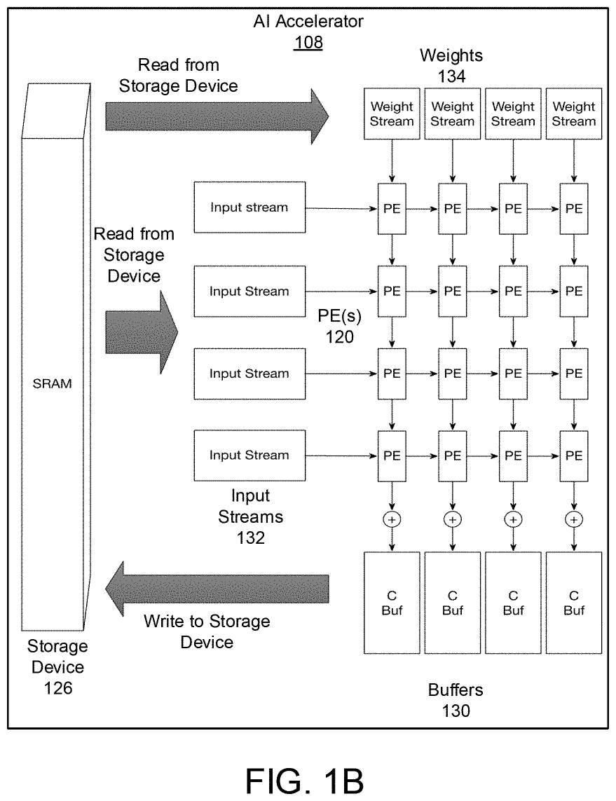

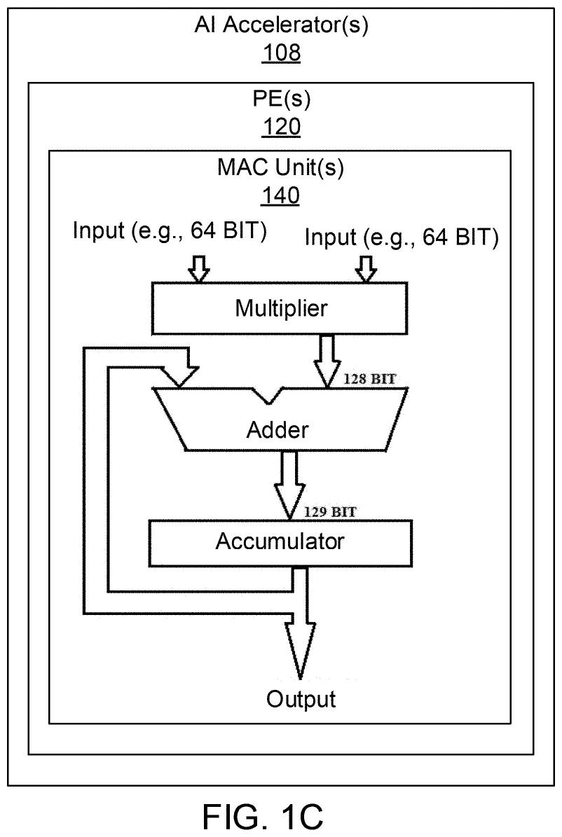

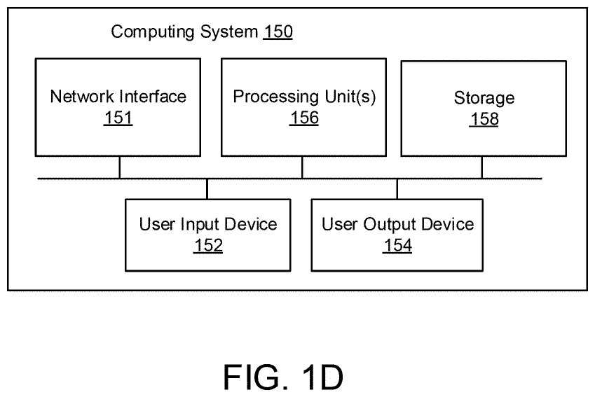

Prior to discussing the specifics of embodiments of systems, devices and/or methods in Section B, it may be helpful to discuss the environments, systems, configurations and/or other aspects useful for practicing or implementing certain embodiments of the systems, devices and/or methods. Referring now to FIG. 1A, an embodiment of a system for performing artificial intelligence (AI) related processing is depicted. In brief overview, the system includes one or more AI accelerators 108 that can perform AI related processing using input data 110. Although referenced as an AI accelerator 108, it is sometimes referred as a neural network accelerator (NNA), neural network chip or hardware, AI processor, AI chip, etc. The AI accelerator(s) 108 can perform AI related processing to output or provide output data 112, according to the input data 110 and/or parameters 128 (e.g., weight and/or bias information). An AI accelerator 108 can include and/or implement one or more neural networks 114 (e.g., artificial neural networks), one or more processor(s) and/or one or more storage devices 126.

Each of the above-mentioned elements or components is implemented in hardware, or a combination of hardware and software. For instance, each of these elements or components can include any application, program, library, script, task, service, process or any type and form of executable instructions executing on hardware such as circuitry that can include digital and/or analog elements (e.g., one or more transistors, logic gates, registers, memory devices, resistive elements, conductive elements, capacitive elements).

The input data 110 can include any type or form of data for configuring, tuning, training and/or activating a neural network 114 of the AI accelerator(s) 108, and/or for processing by the processor(s) 124. The neural network 114 is sometimes referred to as an artificial neural network (ANN). Configuring, tuning and/or training a neural network can refer to or include a process of machine learning in which training datasets (e.g., as the input data 110) such as historical data are provided to the neural network for processing. Tuning or configuring can refer to or include training or processing of the neural network 114 to allow the neural network to improve accuracy. Tuning or configuring the neural network 114 can include, for example, designing the neural network using architectures for that have proven to be successful for the type of problem or objective desired for the neural network 114. In some cases, the one or more neural networks 114 may initiate at a same or similar baseline model, but during the tuning, training or learning process, the results of the neural networks 114 can be sufficiently different such that each neural network 114 can be tuned to process a specific type of input and generate a specific type of output with a higher level of accuracy and reliability as compared to a different neural network that is either at the baseline model or tuned or trained for a different objective or purpose. Tuning the neural network 114 can include setting different parameters 128 for each neural network 114, fine-tuning the parameters 128 differently for each neural network 114, or assigning different weights (e.g., hyperparameters, or learning rates), tensor flows, etc. Thus, by setting appropriate parameters 128 for the neural network(s) 114 based on a tuning or training process and the objective of the neural network(s) and/or the system, this can improve performance of the overall system.

A neural network 114 of the AI accelerator 108 can include any type of neural network including, for example, a convolution neural network (CNN), deep convolution network, a feed forward neural network (e.g., multilayer perceptron (MLP)), a deep feed forward neural network, a radial basis function neural network, a Kohonen self-organizing neural network, a recurrent neural network, a modular neural network, a long/short term memory neural network, etc. The neural network(s) 114 can be deployed or used to perform data (e.g., image, audio, video) processing, object or feature recognition, recommender functions, data or image classification, data (e.g., image) analysis, etc., such as natural language processing.

As an example, and in one or more embodiments, the neural network 114 can be configured as or include a convolution neural network. The convolution neural network can include one or more convolution cells (or pooling layers) and kernels, that can each serve a different purpose. The convolution neural network can include, incorporate and/or use a convolution kernel (sometimes simply referred as “kernel”). The convolution kernel can process input data, and the pooling layers can simplify the data, using, for example, non-linear functions such as a max, thereby reducing unnecessary features. The neural network 114 including the convolution neural network can facilitate image, audio or any data recognition or other processing. For example, the input data 110 (e.g., from a sensor) can be passed to convolution layers of the convolution neural network that form a funnel, compressing detected features in the input data 110. The first layer of the convolution neural network can detect first characteristics, the second layer can detect second characteristics, and so on.

The convolution neural network can be a type of deep, feed-forward artificial neural network configured to analyze visual imagery, audio information, and/or any other type or form of input data 110. The convolution neural network can include multilayer perceptrons designed to use minimal preprocessing. The convolution neural network can include or be referred to as shift invariant or space invariant artificial neural networks, based on their shared-weights architecture and translation invariance characteristics. Since convolution neural networks can use relatively less pre-processing compared to other data classification/processing algorithms, the convolution neural network can automatically learn the filters that may be hand-engineered for other data classification/processing algorithms, thereby improving the efficiency associated with configuring, establishing or setting up the neural network 114, thereby providing a technical advantage relative to other data classification/processing techniques.

The neural network 114 can include an input layer 116 and an output layer 122, of neurons or nodes. The neural network 114 can also have one or more hidden layers 118, 119 that can include convolution layers, pooling layers, fully connected layers, and/or normalization layers, of neurons or nodes. In a neural network 114, each neuron can receive input from some number of locations in the previous layer. In a fully connected layer, each neuron can receive input from every element of the previous layer.

Each neuron in a neural network 114 can compute an output value by applying some function to the input values coming from the receptive field in the previous layer. The function that is applied to the input values is specified by a vector of weights and a bias (typically real numbers). Learning (e.g., during a training phase) in a neural network 114 can progress by making incremental adjustments to the biases and/or weights. The vector of weights and the bias can be called a filter and can represents some feature of the input (e.g., a particular shape). A distinguishing feature of convolutional neural networks is that many neurons can share the same filter. This reduces memory footprint because a single bias and a single vector of weights can be used across all receptive fields sharing that filter, rather than each receptive field having its own bias and vector of weights.

For example, in a convolution layer, the system can apply a convolution operation to the input layer 116, passing the result to the next layer. The convolution emulates the response of an individual neuron to input stimuli. Each convolutional neuron can process data only for its receptive field. Using the convolution operation can reduce the number of neurons used in the neural network 114 as compared to a fully connected feedforward neural network. Thus, the convolution operation can reduces the number of free parameters, allowing the network to be deeper with fewer parameters. For example, regardless of an input data (e.g., image data) size, tiling regions of size 5×5, each with the same shared weights, may use only 25 learnable parameters. In this way, the first neural network 114 with a convolution neural network can resolve the vanishing or exploding gradients problem in training traditional multi-layer neural networks with many layers by using backpropagation.

The neural network 114 (e.g., configured with a convolution neural network) can include one or more pooling layers. The one or more pooling layers can include local pooling layers or global pooling layers. The pooling layers can combine the outputs of neuron clusters at one layer into a single neuron in the next layer. For example, max pooling can use the maximum value from each of a cluster of neurons at the prior layer. Another example is average pooling, which can use the average value from each of a cluster of neurons at the prior layer.

The neural network 114 (e.g., configured with a convolution neural network) can include fully connected layers. Fully connected layers can connect every neuron in one layer to every neuron in another layer. The neural network 114 can be configured with shared weights in convolutional layers, which can refer to the same filter being used for each receptive field in the layer, thereby reducing a memory footprint and improving performance of the first neural network 114.

The hidden layers 118, 119 can include filters that are tuned or configured to detect information based on the input data (e.g., sensor data, from a virtual reality system for instance). As the system steps through each layer in the neural network 114 (e.g., convolution neural network), the system can translate the input from a first layer and output the transformed input to a second layer, and so on. The neural network 114 can include one or more hidden layers 118, 119 based on the type of object or information being detected, processed and/or computed, and the type of input data 110.

In some embodiments, the convolutional layer is the core building block of a neural network 114 (e.g., configured as a CNN). The layer's parameters 128 can include a set of learnable filters (or kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the neural network 114 can learn filters that activate when it detects some specific type of feature at some spatial position in the input. Stacking the activation maps for all filters along the depth dimension forms the full output volume of the convolution layer. Every entry in the output volume can thus also be interpreted as an output of a neuron that looks at a small region in the input and shares parameters with neurons in the same activation map. In a convolutional layer, neurons can receive input from a restricted subarea of the previous layer. Typically the subarea is of a square shape (e.g., size 5 by 5). The input area of a neuron is called its receptive field. So, in a fully connected layer, the receptive field is the entire previous layer. In a convolutional layer, the receptive area can be smaller than the entire previous layer.

The first neural network 114 can be trained to detect, classify, segment and/or translate input data 110 (e.g., by detecting or determining the probabilities of objects, events, words and/or other features, based on the input data 110). For example, the first input layer 116 of neural network 114 can receive the input data 110, process the input data 110 to transform the data to a first intermediate output, and forward the first intermediate output to a first hidden layer 118. The first hidden layer 118 can receive the first intermediate output, process the first intermediate output to transform the first intermediate output to a second intermediate output, and forward the second intermediate output to a second hidden layer 119. The second hidden layer 119 can receive the second intermediate output, process the second intermediate output to transform the second intermediate output to a third intermediate output, and forward the third intermediate output to an output layer 122. The output layer 122 can receive the third intermediate output, process the third intermediate output to transform the third intermediate output to output data 112, and forward the output data 112 (e.g., possibly to a post-processing engine, for rendering to a user, for storage, and so on). The output data 112 can include object detection data, enhanced/translated/augmented data, a recommendation, a classification, and/or segmented data, as examples.

Referring again to FIG. 1A, the AI accelerator 108 can include one or more storage devices 126. A storage device 126 can be designed or implemented to store, hold or maintain any type or form of data associated with the AI accelerator(s) 108. For example, the data can include the input data 110 that is received by the AI accelerator(s) 108, and/or the output data 112 (e.g., before being output to a next device or processing stage). The data can include intermediate data used for, or from any of the processing stages of a neural network(s) 114 and/or the processor(s) 124. The data can include one or more operands for input to and processing at a neuron of the neural network(s) 114, which can be read or accessed from the storage device 126. For example, the data can include input data, weight information and/or bias information, activation function information, and/or parameters 128 for one or more neurons (or nodes) and/or layers of the neural network(s) 114, which can be stored in and read or accessed from the storage device 126. The data can include output data from a neuron of the neural network(s) 114, which can be written to and stored at the storage device 126. For example, the data can include activation data, refined or updated data (e.g., weight information and/or bias information, activation function information, and/or other parameters 128) for one or more neurons (or nodes) and/or layers of the neural network(s) 114, which can be transferred or written to, and stored in the storage device 126.

In some embodiments, the AI accelerator 108 can include one or more processors 124. The one or more processors 124 can include any logic, circuitry and/or processing component (e.g., a microprocessor) for pre-processing input data for any one or more of the neural network(s) 114 or AI accelerator(s) 108, and/or for post-processing output data for any one or more of the neural network(s) 114 or AI accelerator(s) 108. The one or more processors 124 can provide logic, circuitry, processing component and/or functionality for configuring, controlling and/or managing one or more operations of the neural network(s) 114 or AI accelerator(s) 108. For instance, a processor 124 may receive data or signals associated with a neural network 114 to control or reduce power consumption (e.g., via clock-gating controls on circuitry implementing operations of the neural network 114). As another example, a processor 124 may partition and/or re-arrange data for separate processing (e.g., at various components of an AI accelerator 108), sequential processing (e.g., on the same component of an AI accelerator 108, at different times), or for storage in different memory slices of a storage device, or in different storage devices. In some embodiments, the processor(s) 124 can configure a neural network 114 to operate for a particular context, provide a certain type of processing, and/or to address a specific type of input data, e.g., by identifying, selecting and/or loading specific weight, activation function and/or parameter information to neurons and/or layers of the neural network 114.

In some embodiments, the AI accelerator 108 is designed and/or implemented to handle or process deep learning and/or AI workloads. For example, the AI accelerator 108 can provide hardware acceleration for artificial intelligence applications, including artificial neural networks, machine vision and machine learning. The AI accelerator 108 can be configured for operation to handle robotics, internet of things and other data-intensive or sensor-driven tasks. The AI accelerator 108 may include a multi-core or multiple processing element (PE) design, and can be incorporated into various types and forms of devices such as artificial reality (e.g., virtual, augmented or mixed reality) systems, smartphones, tablets, and computers. Certain embodiments of the AI accelerator 108 can include or be implemented using at least one digital signal processor (DSP), co-processor, microprocessor, computer system, heterogeneous computing configuration of processors, graphics processing unit (GPU), field-programmable gate array (FPGA), and/or application-specific integrated circuit (ASIC). The AI accelerator 108 can be a transistor based, semiconductor based and/or a quantum computing based device.

Referring now to FIG. 1B, an example embodiment of a device for performing AI related processing is depicted. In brief overview, the device can include or correspond to an AI accelerator 108, e.g., with one or more features described above in connection with FIG. 1A. The AI accelerator 108 can include one or more storage devices 126 (e.g., memory such as a static random-access memory (SRAM) device), one or more buffers, a plurality or array of processing element (PE) circuits, other logic or circuitry (e.g., adder circuitry), and/or other structures or constructs (e.g., interconnects, data buses, clock circuitry, power network(s)). Each of the above-mentioned elements or components is implemented in hardware, or at least a combination of hardware and software. The hardware can for instance include circuit elements (e.g., one or more transistors, logic gates, registers, memory devices, resistive elements, conductive elements, capacitive elements, and/or wire or electrically conductive connectors).

In a neural network 114 (e.g., artificial neural network) implemented in the AI accelerator 108, neurons can take various forms and can be referred to as processing elements (PEs) or PE circuits. The PEs are connected into a particular network pattern or array, with different patterns serving different functional purposes. The PE in an artificial neural network operate electrically (e.g., in a semiconductor implementation), and may be either analog, digital, or a hybrid. To parallel the effect of a biological synapse, the connections between PEs can be assigned multiplicative weights, which can be calibrated or “trained” to produce the proper system output.

PE can be defined in terms of the following equations (e.g., which represent a McCulloch-Pitts model of a neuron):

ζ=Σᵢwᵢxᵢ (1)

y=σ(ζ) (2)

Where ζ is the weighted sum of the inputs (e.g., the inner product of the input vector and the tap-weight vector), and σ(ζ) is a function of the weighted sum. Where the weight and input elements form vectors w and x, the ζ weighted sum becomes a simple dot product:

ζ=w·x (3)

This may be referred to as either the activation function (e.g., in the case of a threshold comparison) or a transfer function. In some embodiments, one or more PEs can be referred to as a dot product engine. The input (e.g., input data 110) to the neural network 114, x, can come from an input space and the output (e.g., output data 112) are part of the output space. For some network networks, the output space Y may be as simple as {0, 1}, or it may be a complex multi-dimensional (e.g., multiple channel) space (e.g., for a convolutional neural network). Neural networks tend to have one input per degree of freedom in the input space, and one output per degree of freedom in the output space.

Referring again to FIG. 1B, the input x to a PE 120 can be part of an input stream 132 that is read from a storage device 126 (e.g., SRAM). An input stream 132 can be directed to one row (horizontal bank or group) of PEs, and can be shared across one or more of the PEs, or partitioned into data portions (overlapping or non-overlapping portions) as inputs for respective PEs. Weights 134 (or weight information) in a weight stream 134 (e.g., read from the storage device 126) can be directed or provided to a column (vertical bank or group) of PEs. Each of the PEs in the column may share the same weight 134 or receive a corresponding weight 134. The input and/or weight for each target PE can be directly routed (e.g., from the storage device 126) to the target PE, or routed through one or more PEs (e.g., along a row or column of PEs) to the target PE. The output of each PE can be routed directly out of the PE array, or through one or more PEs (e.g., along a column of PEs) to exit the PE array. The outputs of each column of PEs can be summed or added at an adder circuitry of the respective column, and provided to a buffer 130 for the respective column of PEs. The buffer(s) 130 can provide, transfer, route, write and/or store the received outputs to the storage device 126. In some embodiments, the outputs (e.g., activation data from one layer of the neural network) that are stored to the storage device 126 can be retrieved or read from the storage device 126, and be used as inputs to the array of PEs 120 for processing (of a subsequent layer of the neural network) at a later time. In some embodiments, the outputs that are stored to the storage device 126 can be retrieved or read from the storage device 126 as output data 112 for the AI accelerator 108.

Referring now to FIG. 1C, one example embodiment of a device for performing AI related processing is depicted. In brief overview, the device can include or correspond to an AI accelerator 108, e.g., with one or more features described above in connection with FIGS. 1A and 1B. The AI accelerator 108 can include one or more PEs 120, other logic or circuitry (e.g., adder circuitry), and/or other structures or constructs (e.g., interconnects, data buses, clock circuitry, power network(s)). Each of the above-mentioned elements or components is implemented in hardware, or at least a combination of hardware and software. The hardware can for instance include circuit elements (e.g., one or more transistors, logic gates, registers, memory devices, resistive elements, conductive elements, capacitive elements, and/or wire or electrically conductive connectors).

In some embodiments, a PE 120 can include one or more multiply-accumulate (MAC) units or circuits 140. One or more PEs can sometimes be referred to as a MAC engine. A MAC unit is configured to perform multiply-accumulate operation(s). The MAC unit can include a multiplier circuit, an adder circuit and/or an accumulator circuit. The multiply-accumulate operation computes the product of two numbers and adds that product to an accumulator. The MAC operation can be represented as follows, in connection with an accumulator a, and inputs b and c:

a←a+(b×c) (4)

In some embodiments, a MAC unit 140 may include a multiplier implemented in combinational logic followed by an adder (e.g., that includes combinational logic) and an accumulator register (e.g., that includes sequential and/or combinational logic) that stores the result. The output of the accumulator register can be fed back to one input of the adder, so that on each clock cycle, the output of the multiplier can be added to the register.

As discussed above, a MAC unit 140 can perform both multiply and addition functions. The MAC unit 140 can operate in two stages. The MAC unit 140 can first compute the product of given numbers (inputs) in a first stage, and forward the result for the second stage operation (e.g., addition and/or accumulate). An n-bit MAC unit 140 can include an n-bit multiplier, 2n-bit adder, and 2n-bit accumulator.

Various systems and/or devices described herein can be implemented in a computing system. FIG. 1D shows a block diagram of a representative computing system 150. In some embodiments, the system of FIG. 1A can form at least part of the processing unit(s) 156 of the computing system 150. Computing system 150 can be implemented, for example, as a device (e.g., consumer device) such as a smartphone, other mobile phone, tablet computer, wearable computing device (e.g., smart watch, eyeglasses, head mounted display), desktop computer, laptop computer, or implemented with distributed computing devices. The computing system 150 can be implemented to provide VR, AR, MR experience. In some embodiments, the computing system 150 can include conventional, specialized or custom computer components such as processors 156, storage device 158, network interface 151, user input device 152, and user output device 154.

Network interface 151 can provide a connection to a local/wide area network (e.g., the Internet) to which network interface of a (local/remote) server or back-end system is also connected. Network interface 151 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 152 can include any device (or devices) via which a user can provide signals to computing system 150; computing system 150 can interpret the signals as indicative of particular user requests or information. User input device 152 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 154 can include any device via which computing system 150 can provide information to a user. For example, user output device 154 can include a display to display images generated by or delivered to computing system 150. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 154 can be provided in addition to or instead of a display. Examples include indicator lights, speakers, tactile “display” devices, printers, and so on.

Some implementations include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 156 can provide various functionality for computing system 150, including any of the functionality described herein as being performed by a server or client, or other functionality associated with message management services.

It will be appreciated that computing system 150 is illustrative and that variations and modifications are possible. Computer systems used in connection with the present disclosure can have other capabilities not specifically described here. Further, while computing system 150 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

### B. Radioactive Data Generation

The subject matter of this disclosure is directed to determining if a particular dataset (e.g., image dataset) has been used to train a neural network model (e.g., a convolutional neural network, residual neural network) through the incorporation of defined marker data (sometimes referred as radioactive data). The defined marker data can be applied to data within at least one class of a dataset to mark the respective data. The dataset can be included within a class of a plurality of classes of datasets (e.g., class specific additive mark) provided to train a neural network model. The model, characteristics of the model and/or the outputs of the model can be examined to detect if the marked data was used to train the model. For example, a statistical value can be generated by a device (e.g., detector) indicating whether the dataset from a particular originator (or source) was used to train the model, which can provide protection of the originator's rights with respect to the dataset and/or control of usage of the dataset. The statistical value can include or correspond to a similarity score (e.g., cosine similarity score) between characteristics of the model and characteristics of the defined marker data. The availability of large scale public databases has accelerated the development of machine learning. However, privacy and/or protection of data can be compromised due to the ease of access to the public databases. For example, once a dataset is released or published, it can be difficult for an originator of a dataset to restrict access to the dataset, to control its usage in downstream or in later applications, or to provide evidence that the dataset has been used for training models.

The devices, systems and methods described herein can incorporate markers in a dataset that transfers to the model in the process of training, such that the markers can be detected from the trained neural network model to provide an indication to an originator of the dataset that the originator's dataset was used in training the neural network model. In some embodiments, the method can include marking, training and detection phases, stages, or operations. During the marking operation, defined marker data (e.g., radioactive mark) can be added to unmarked or vanilla training images of a dataset without changing the labels of the respective data. For example, the dataset can include an image dataset and the images can include a three-dimensional (3D) tensor having dimensions in terms of height, width and/or color channel. The defined marker can include, but is not limited to, an isotropic unit vector (e.g., random isotropic unit vector) added to features of the images from at least one class of data. The direction of the isotropic unit vector (e.g., direction vector) can correspond to the carrier and be used to detect the marked images subsequent to training a neural network model. In some embodiments, the defined marker can be visually imperceptible and instead detectable through a signal to noise ratio value. For example, the defined marker applied to the images can be determined or measured using an image quality metric, such as a peak signal to noise ratio (PSNR). The defined marker can be applied to be reasonably neutral with respect to accuracy of the model trained using the marked dataset. The defined marker can be incorporated with the data through the training operation (e.g., learning process), for example, and provided to the neural network (e.g., convolutional neural network).

During the detection phase or operation, the properties of a linear classifier or classifier vector of the neural network model can be detected to determine if the neural network model was trained using the marked dataset. A determination can be made if the neural network model has seen or processed the marked data or been trained using the marked data from the respective dataset. For example, in some embodiments, the linear classifier can have a positive dot product (e.g., that is larger than a defined threshold value) with the direction of the carrier of the defined marker (e.g., direction of the isotropic unit vector) applied to the dataset if the neural network model was trained using the marked dataset. The devices, systems and methods described herein can determine if the linear classifier is aligned with the direction vector of the defined marker. The level of alignment or correlation between the linear classifier and direction vector of the marker can provide a statistical value (e.g., cosine similarity score) indicating if that the marked dataset has been used to train the neural network model.

The datasets that are marked are not limited to image datasets, and can be any type of datasets with content units that are represented via continuous values (e.g., has multiple levels, transitions or values that are graduated in nature) instead of binary or disjointed values (e.g., text letters). Examples of suitable types of datasets include images (e.g., of animals, dogs, buildings, objects, sceneries), video frames, and audio data. The defined markers inserted into data of a dataset can have vectors of the same direction (e.g., same carrier). The neural network (that are trained with the marked datasets) can be any type of neural network, such as a residual NN or a recursive/recurrent NN. The device or detector may use a pre-trained model to detect if a trained version of the model has used a marked dataset during training. The marked datasets can be associated with a distinct class, as this class is intended to be recognized by the model being trained, and can be “imprinted” into the trained model. In some embodiments, detection can be achieved with 1% or more of datasets that are marked, with a high confidence. The confidence (e.g., p value) can be computed by the detector to supplement the detection result/decision.

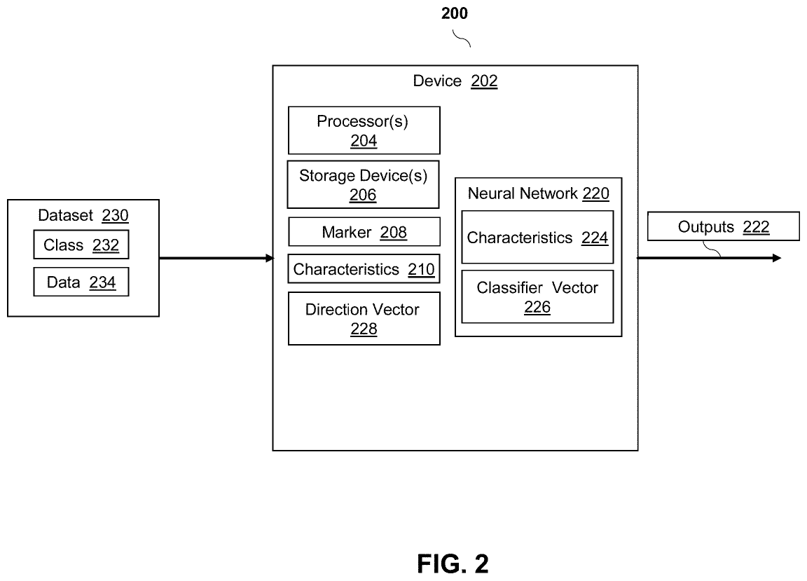

Referring now to FIG. 2, an example system 200 for generating radioactive data is provided. In brief overview, the system 200 can include a device 202 to receive one or more datasets 230, provide the one or more datasets 230 to a neural network 220 and determine if the neural network 220 was trained using a particular dataset 230. For example, the device 202 can execute or perform one or more of: a marking stage, a training stage and a detection stage. The device 202, during a marking stage, can apply a defined marker 208 to a class 232 of data 234 of a dataset 230. The device 202, during the training stage, can provide the defined marked data 234 and/or unmarked data 234 (e.g., vanilla data, unmodified data) to a neural network 220. In some embodiments, the training stage can include using defined marker data 208 and/or unmarked data 234 to train a classifier vector 226 (e.g., multi-class classifier) of the neural network 220. The device 202, during the detection stage, can include determining if the neural network 220 has been trained using the defined marker data 208.

In some embodiments, the system 200 includes more, fewer, or different components than shown in FIG. 2. In some embodiments, functionality of one or more components of the system 200 can be distributed among the components in a different manner than is described here. Various components and elements of the system 200 may be implemented on or using components or elements of the computing environment shown in FIG. 1D and previously described. For instance, the device 202 may include or incorporate a computing system similar to the computing system 150 shown in FIG. 1D and previously described. The device 202 may include one or more processing unit(s) 156, storage 158, a network interface 151, user input device 152, and/or user output device 154.

The device 202 can include a computing system or WiFi device. In some embodiments, the device 202 can be implemented, for example, as a computing device, smartphone, other mobile phone, device (e.g., consumer device), desktop computer, laptop computer, personal computer (PC), or implemented with distributed computing devices. In some embodiments, the device 202 can include conventional, specialized or custom computer components such as processors 204, a storage device 206, a network interface, a user input device, and/or a user output device. In embodiments, the device 202 may include some elements of the device shown in FIG. 1D and previously described.

The device 202 can include one or more processors 204. The one or more processors 204 can include any logic, circuitry and/or processing component (e.g., a microprocessor) for pre-processing input data (e.g., datasets 230) for the device 202, and/or for post-processing output data (e.g., outputs 222) for the device 202. The one or more processors 204 can provide logic, circuitry, processing component and/or functionality for configuring, controlling and/or managing one or more operations of the device 202. For instance, a processor 204 may receive data and metrics for, including but not limited to, datasets 230, defined marker 208, characteristics 210, 224, classifier vector 226, and direction vector 228.

The device 202 can include a storage device 206. The storage device 206 can be designed or implemented to store, hold or maintain any type or form of data associated with the device 202. For example, the device 202 can store data corresponding to one or more of datasets 230, defined marker 208, characteristics 210, 224, classifier vector 226, and direction vector 228. The storage device 206 can include a static random access memory (SRAM) or internal SRAM, internal to the device 202. In embodiments, the storage device 206 can be included within an integrated circuit of the device 202. The storage device 206 can include a memory (e.g., memory, memory unit, storage device, etc.). The memory may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an example embodiment, the memory is communicably connected to the processor 204 via a processing circuit and includes computer code for executing (e.g., by the processing circuit and/or the processor) the one or more processes or methods (e.g., method 300) described herein.

The device 202 can include, correspond to or be the same as an AI accelerator 108 (e.g., AI accelerator 108 of FIGS. 1A-1D). For example, the device 202 can include or execute a neural network 220 (e.g., neural network model). In some embodiments, the neural network 220 can include a convolutional neural network, a recurrent neural network, a residual neural network or a combination of one or more convolutional neural networks, one or more recurrent neural networks and/or one or more residual neural networks. The neural network 220 can be the same as or substantially similar to the neural network 114 described above with respect to FIGS. 1A-1D.

The device 202 can generate a defined marker 208. The defined marker 208 can include or correspond to a random isotropic unit vector (e.g., random defined marker 208). The defined marker 208 can include a random direction vector 228. For example, the device can randomly generate or sample the direction vector 228 for the defined marker 208. The direction vector 228 can include or correspond to carrier of the defined marker 208. In some embodiments, the defined marker 208 can include, be referred to or correspond to a radioactive marker or radioactive data. The defined marker 208 can include one or more characteristics 210, including but not limited to, the direction vector 228, a signal to noise ratio, data augmentation properties, a pixel value, and/or a pixel color value.

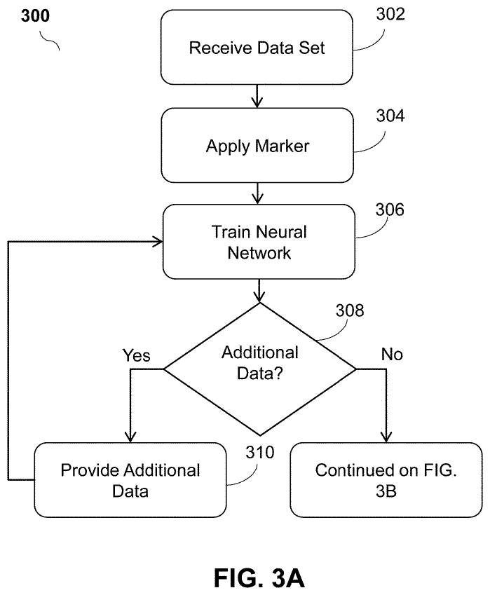

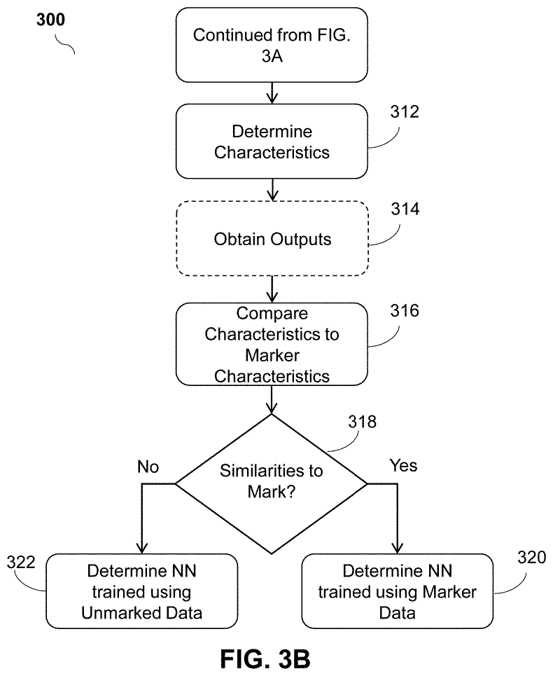

Now referring to FIGS. 3A-3B, a method 300 for radioactive data generation is depicted. In brief overview, the method 300 can include one or more of: receiving a dataset (302), applying a defined marker (304), training a neural network (306), determining if additional data is available to provide to the neural network (308), providing additional data (310), determining characteristics (312), obtaining outputs (314), comparing to marker characteristics (316), identifying if any similarities exist between neural network characteristics and marker characteristics (318), determining the neural network was trained using the defined marker data (320) and determining the neural network was not trained using the defined marker data (322). Any of the foregoing operations may be performed by any one or more of the components or devices described herein, for example, the device 202 and/or one or more processors.

Referring to 302, and in some embodiments, one or more datasets can be received. A device 202 can receive a dataset 230. The dataset 230 can include data 234 generated by and/or collected by at least one originator or administrator of the respective data 234. In some embodiments, an originator of data 234 can include or correspond to an individual, company or organization responsible for or having an interest in protecting the respective data 234. The device 202 can receive a dataset 230 from at least one originator, or datasets 230 from a plurality of originators (e.g., different originators, multiple datasets from same originator). The dataset 230 can include or correspond to a plurality of classes 232 of data 234. In some embodiments, the device 202 can group or organize the data 234 into one or more classes 232. For example, a class 232 can include or correspond to data 234 (e.g., data points) having one or more common or similar properties, formats, data structures and/or attributes. In some embodiments, a class 232 of data 234 can include data 234 referring to and/or describing one or more common or similar properties and differentiated by other data 234 in one or more datasets 230 by kind, type, content and/or quality. For example, a class 232 of data 234 can include, but not limited to, categories, places, cities, natural objects (e.g., dogs, cats, plants) or structures. In some embodiments, the dataset 230 can include a plurality of images organized or grouped into a plurality of classes 232 (e.g., a dataset of natural images with 1,281,167 images belonging to 1,000 classes).

The data 234 forming the dataset 230 can include, but not limited to, image data, audio data, and/or video data. In some embodiments, the data 234 can include a continuous signal or be provided to the device 202 in the form of a continuous signal (e.g., continuous stream or variation of data or values). The continuous signal can have or include a determined length corresponding to a length of time from a start of the signal to an end of the signal. The continuous signal can include a stream or variation of data/values over a range of time values with different points in the stream/variation of data/values corresponding to different points within the range of time values such that at different points within the stream/variation of data/values a different frame or data point is provided. For example, the data can include a continuous stream of image, audio or video data having an initial point (e.g., start of signal, start of stream) at a first time period and an end point (e.g., end of stream) at a second time period, different from the first time period. In one embodiment, the data 234 can include a plurality of images provided in the form of a stream of images such that the stream of images includes a start point at a first time period for a first image of the plurality of images and an end point at a second time period for a final or last image of the plurality of images.

The dataset 230 can include a vector or be provided as a vector. For example, in some embodiments, the data 234 can include image data (“x”) that is a three dimensional tensor having dimensions in terms of height, width, and color channel. The image data 234 can be included within a classifier with C classes 232 composed of a feature extraction function ϕ: x→ϕ(x)∈ [symbol] ^{d} (e.g., a convolutional neural network, neural network 220) followed by a linear classifier with weights (wi)i=1 . . . C∈ [symbol] ^{d}. The classifier can classify the image data “x” 234 as:

$${argmax}_{i = 1. . C} {w}_{i}^{T} ϕ ( x ) \qquad ( 5 )$$

Referring to 304, and in some embodiments, a defined marker can be applied to data. The device 202 can apply, insert or incorporate a defined marker 208 into data 234 of at least one class 232 (e.g., a first class) of the dataset 230. For example, the device 202 can apply the defined marker 208 to each data point or a portion of data points within the selected class 232 of the dataset 230. In some embodiments, the device 202 can apply or insert the defined marker 208 (e.g., radioactive mark) into images of the dataset 230 to generate marked data 234. The defined marker 208 can include a radioactive mark and/or a random isotropic unit vector applied to data 234 in at least one class 232 (e.g., a first class) of the dataset 230. For example, the defined marker 208 (or “mark”) can include a random isotropic unit vector u∈ [symbol] d with ∥u∥₂=1 (e.g., direction vector 228). The direction vector “u” can refer to or correspond to the carrier of the defined marker 208. The device 202 can apply the defined marker 208 to the features of a portion of a class 232 of data 234 or to all data 234 included in the respective class 232. The features of data 234 can include, but are not limited to, one or more pixels of an image, resized or cropped image, a bit of data, metadata, attributes or properties of an image file, attributes or properties of an audio file and/or attributes or properties of a video file. In some embodiments, the device 202 can apply the defined marker 208 to the features of the data 234 such that the defined marker 208 is invisible, undetectable or unnoticeable to the human eye. In one embodiment, the data 234 can include image data, and applying the defined marker 208 can include modifying one or more bits (or pixels) in the image from a first color pixel level to a second different pixel color level (e.g., modify one or more pixels of an image to a grayscale pixel level such that the modifications are invisible, undetectable or unnoticeable to the human eye).

In some embodiments, during a marking stage, the device 202 can sample independent and identically distributed (i.i.d.) random direction vectors 228 (u₁)_{i=1 . . . C} and can apply or add the direction vector 228 of the defined marker 208 to the features of data 234 (e.g., images) of a class “i” 232 of the dataset 230. The marking performed by the device 202 can include or correspond to data augmentation of the respective dataset 230, and the device 202 can monitor or track the time of marking or time to perform the marking. For example, given an augmentation parameter θ, the input to the neural network 220 may not be the image \tilde{x} but instead is the transformed version F (θ, \tilde{x}). The device 202 can perform data augmentation, for example, to crop and/or resize transformations, so θ are the coordinates of the center and/or size of the cropped images for an image data 234.

In some embodiments, the defined marker 208 can include or correspond to a fixed known feature extractor ϕ. For example, the device 202 can determine or use a fixed known feature extractor ϕ to mark the data 234. At time of marking, the device 202 can modify features of data “x” 234 (e.g., pixels of an image) such that the features ϕ(x) would move in the direction u. For example, using image data 234, the device 202 can perform backpropagation for gradients in the image space. In some embodiments, the device 202 can optimize over the pixel space by running the following example optimization program:

$$\check{x} , ‖ \tilde{x} - x {‖}^{min} ∞ \leq {R}^{ℒ ( \tilde{x} )} \qquad ( 6 )$$

where the radius R is a hard upper bound on the change of color levels of the image data 234 provided to the neural network 220. The device 202 can apply the defined marker 208 to a determined portion, percentage or fraction of the total dataset 230. For example, device 202 can apply the defined marker 208 to a portion of the dataset ranging from 1% to 20% of the total dataset 230. In some embodiments, the device 202 can apply the defined marker 208 to the entire dataset 230 (e.g., 100%). The portion of the dataset 230 marked can vary and be selected based at least in part on a size of the dataset 230 and/or one or more policies (e.g., administrator policies, device policies, neural network policies).

Referring to 306, and in some embodiments, a neural network can be trained. The device 202 can train a neural network 220 (e.g., neural network model) using the one or more datasets 230. For example, the device 202 can provide one or more datasets 230 to the neural network 220. The datasets 230 may include marked data 234 and/or unmarked data 234 corresponding to data 234. Marked data 234 can include or correspond to data 234 modified using the defined marker 208, and unmarked data 234 can include data 234 that is not modified using the defined marker 208. The neural network 220 can include or correspond to a convolutional neural network, recurrent neural network, a residual network (e.g., ResNet 18 model, ResNet 50 Model) or another type of network or model.

The neural network 220 can be trained by the data 234 such that the characteristics 224 and/or outputs 222 of the neural network 220 change or are modified by the provided data 234. In some embodiments, if the marked data 234 is used or provided to the neural network 220 during, for example, a training stage, a classifier vector 226 (e.g., linear classifier) of the corresponding class w can be updated with weighted sums of ϕ(x)+αu, where α is the strength of the mark 208. The device 202 can determine that the classifier vector 226 of the class w can have a positive dot product with the direction u when the neural network 220 has been trained using the defined marker data 208. For example, the device 202 can execute or perform the training stage by training the feature extractor ϕ. In the marking stage, the device 202 can use the feature extractor ϕ₀ to generate the mark 208 (e.g., radioactive data). During the training stage, the device 202 can train a new feature extractor ϕₜ with a classification matrix W=[w₁, . . . , w_{C}]∈ [symbol] ^{d×C}. The device 202 can train the ϕₜ from an initial or first value (e.g., beginning value), thus the output spaces ϕ₀ and ϕₜ may not correspond to each other. The neural network 220 can be invariant to permutation and rescaling.

The device 202 can provide the dataset 230 to the neural network 220 to train the neural network 220. In some embodiments, the training can include an algorithm (e.g., learning algorithm) and a set of data augmentations. For example, the device 202 can train a stochastic gradient descent (SGD) with a determined momentum (e.g., 0.9) and a determined weight decay (e.g., 10-4) for a determined time period (e.g., 90 epochs) using a sample dataset 230 (e.g., batch size of 2048). The device 202 can determine or select the determined momentum, determined weight decay and determined time period for each respective training period, and the respective values can vary based at least in part on the characteristics of the dataset 230 provided. The device 202 can execute the algorithm and apply the data augmentations settings (e.g., random crop resized to 224×224) to the sample dataset 230. In some embodiments, the learning or training of the neural network 220 can use a determined learning rate schedule (e.g., waterfall learning rate schedule). For example, the learning rate schedule can start at the determined value (e.g., 0.8) and can be modified or divided by a factor at determined intervals (e.g., divided by 10 every 30 epochs). In some embodiments, using unmarked data 234, the device 202 can train the neural network 220. The device 202 can provide the unmarked data 234 to the neural network 220, and the neural network 220 can process and generate outputs 222 corresponding to the unmarked data 234.

In some embodiments, the device 202 can perform backpropagation and data augmentations to train the neural network 220. The augmentations can be differentiable with respect to the pixel space, for example, for image data 234. The device 202 can execute backpropagation through the data augmentations or marks 208 applied to the data 234. The device 202 can imitate or emulate the behavior of the augmentations by minimizing for instance:

$$\check{x} , ‖ \tilde{x} - x {‖}^{min} ∞ \leq R {𝔼}_{θ} [ ℒ ( F ( ) ) ] \qquad ( 7 )$$

The device 202 can use the data augmentations to train and modify one or more characteristics 224 of the neural network 220. In some embodiments, the data augmentations can modify one or more outputs 222 of the neural network 220 and/or a loss of the neural network 220.

Referring to 308, and in some embodiments, the device can determine if additional data is to be provided to the neural network. If additional data is to be provided to the neural network, the method 300 can return to (306) and can continue training the neural network 220 with the additional data 234. If no additional data is to be provided to the neural network, the method 300 can proceed to (312) to determine characteristics of the neural network.

Referring to 312, and in some embodiments, one or more characteristics of the neural network can be determined. The device 202 can determine characteristics 224 of a neural network model 220. The characteristics 224 can include, but not limited to, classifier data, vector data, loss values, p-values, weight values and/or confidence scores. For example, the characteristics 224 of the neural network 220 can include a classifier vector 226 of the neural network 220. In some embodiments, the characteristics 224 can include a first loss value from applying first data 234 without the defined marker data (e.g., unmarked data 234) to the neural network model 220, and can include a second loss value from applying second data 234 with the defined marker data (e.g., marked data 234) to the neural network model 220.

The device can monitor and/or collect the characteristics 224 as the neural network 220 as the data 234 (e.g., marked data, unmarked data) is provided to the neural network 220 and/or after the neural network 220 has processed the data 234. For example, the device 202 can determine or identify changes in one or more characteristics 224 of the neural network 220 in response to provided data 234 (e.g., marked data 234, unmarked data 234). The device 202 can determine characteristics of the neural network 220 to determine if the neural network was trained using the marked data 234. For example, the device 202 can analyze the neural network 220 (e.g., contaminated models) for the presence of the defined marker 208.

The device 202 can determine one or more characteristics 224, including but not limited to, a peak signal to noise ratio (PSNR) and/or p-values. In some embodiments, the peak signal to noise ratio can include or correspond to a magnitude of the perturbation used to apply the mark 208 to the data 234. The p-values can include or correspond to a confidence score indicating a confidence that the marked data 234 was used to train the neural network 220. In some embodiments, the device 202 can perform the tests or experiments using a portion, percentage or fraction (q) of the total dataset 230 (e.g., q∈{0.01, 0.02, 0.05, 0.1, 0.2}) to determine that characteristics 224 of the neural network 220.

In some embodiments, the device 202 can determine a loss of the neural network 220. The loss can for instance include a combination of three terms:

[symbol]

(x)=−(ϕ(\tilde{x})−ϕ(x))^{T}u+λ₁∥\tilde{x}−x∥₂+λ₂∥ϕ(\tilde{x})−ϕ(x)∥₂ (8)

In some embodiments, the first term can encourage or cause the features of the image data 234 to align with the direction u (e.g., cause the features of the image data 234 to be similar to characteristics of the direction vector 228 of the defined marker 208). The second term can penalize the L₂ distance in the image pixel space, and the third term can penalize the L₂ distance in the feature space (e.g., reduce the L₂ distance in the pixel space and the feature space). The device 202 can determine or optimize this objective, for example, performing a stochastic gradient descent (SGD) with a constant learning rate in the image pixel space, projecting back at L_{∞} ball at each step, and rounding to integral pixel values at determined intervals or iterations (e.g., every T=10 iterations). The first term can encourage the features to align with direction vector “u” 228 of the defined marker 208 and the two other terms can penalize the L₂ distance in both pixel and feature space. In some embodiments, the device 202 can optimize this objective by running SGD with a constant learning rate in the pixel space, projecting back into the Lo ball at each step, and rounding to integral pixel values at T=10 iterations to determine loss values for the neural network 220.

Referring to 314, and in some embodiments, one or more outputs of the neural network can be determined. The device 202 can determine or obtain one or more outputs 222 from the neural network. The outputs 222 can be the same as or similar to output data 112 of the neural network 114 described above with respect to FIGS. 1A-1D. In some embodiments, the device 202 can obtain the outputs 222 of the neural network 220, for example, when the characteristics 224 or weight values of the neural network 220 are not available. The weights or other characteristics of the neural network 220 may not be available or accessible and the device 202 can determine if the neural network 220 was trained using the marked data 234 through outputs 222 or output data (e.g., loss) of the neural network 220. For example, the device 202 can determine and/or analyze the loss of the neural network, [symbol] (W^{T}ϕₜ(x),y). If the loss of the neural network 220 is lower on the marked data 234 than on the unmarked data 234, the loss indicates that the neural network 220 was trained using the unmarked data 234. In some embodiments, having access (e.g., unlimited access, partial access) to black box data (e.g., loss data, decision scores), the device 202 can train the neural network 220 or a test neural network 220 to imitate or mimic the outputs of the neural network when loss data and/or decision scores are available and weights of the neural network 220 are not available (e.g., black box model). The device 202 can obtain or collect a first loss value from applying first data 234 without the defined marker data (e.g., unmarked data 234) to the neural network model 220, and a second loss value from applying second data 234 with the defined marker data (e.g., marked data 234) to the neural network model 220.

In some embodiments, the device 202 can determine characteristics 210 of the defined marker data 208. The characteristics 210 of the defined marker data 208 can include a direction vector 228 (e.g., carrier) of the defined marker data 208. The device 202 can determine the characteristic of the direction vector 228 used to generate the defined marker data 208. In some embodiments, the device 202 can determine a first loss value from applying first data 234 without the defined marker data (e.g., unmarked data 234) to the neural network model 220. The device 202 can determine a second loss value from applying second data incorporated with the defined marker data 208 to the neural network model 220.

Referring to 316, and in some embodiments, the characteristics of the neural network can be compared to the characteristics of the defined marker. The device 202 can compare the characteristics 224 of the neural network model 220 with characteristics 210 of a defined marker data. For example, the device 202 can compare the classifier vector 226 of the neural network 220 to the direction vector 228 of the defined marker 208. In some embodiments, the device 202 can perform and/or determine a cosine similarity between the classifier vector 226 and the direction vector 228 to identify one or more similarities between the classifier vector and the direction vector and/or determine if one or more characteristics of the neural network 220 matches one or more characteristics of the defined marker data 208. For example, the device 202 can determine the classifier vector 226 v (e.g., a fixed vector) and the direction vector 228 “u” (e.g., a random vector u) distributed uniformly over a sphere in dimension d (∥u∥₂=1) for the neural network 220. The device 202 can determine the distribution of the respective vectors cosine similarity c(u,v)=u^{T}v/(∥u∥₂∥v∥₂). The cosine similarity can for example follow an incomplete beta distribution with parameters and

$$a = \frac{d - 1}{2} and b = \frac{1}{2} .$$

$$\begin{matrix}ℙ ( c ( u , v ) \geq τ ) = \frac{1}{2} {I}_{1 - {τ}^{2}} ( \frac{d - 1}{2} , \frac{1}{2} ) & ( 9 ) \\ = \frac{{B}_{1 - {τ}^{2}} ( \frac{d - 1}{2} , \frac{1}{2} )}{2 B ( \frac{d - 1}{2} , \frac{1}{2} )} & ( 10 ) \\ = \frac{1}{2 B ( \frac{d - 1}{2} , \frac{1}{2} )} {\int }_{0}^{1 - {τ}^{2}} \frac{{( \sqrt{t} )}^{d - 3}}{\sqrt{1 - t}} dt \\ with & ( 11 ) \\ {B}_{x} ( \frac{d - 1}{2} , \frac{1}{2} ) = {\int }_{0}^{x} \frac{{( \sqrt{t} )}^{d - 3}}{\sqrt{1 - t}} dt \\ and & ( 12 ) \\ B ( \frac{d - 1}{2} , \frac{1}{2} ) = {B}_{1} ( \frac{d - 1}{2} , \frac{1}{2} ) & ( 13 )\end{matrix}$$

In some embodiments, the cosine similarity can have an expectation of 0 and a variance of 1/d. The device 202 can generate a cosine similarity score indicating a relationship or similarity between the classifier vector 226 of the neural network 220 and the direction vector 228 of the defined marker 208. The device 202 can compare the cosine similarity to a threshold value (e.g., cosine similarity threshold) and if the cosine similarity is greater than the threshold, the cosine similarity score can indicate the neural network 220 was trained using the defined marker data 208.

Referring to 318, and in some embodiments, a determination can be made if one or more characteristics of the neural network matches or is similar one or more characteristics of the defined marker. The device 202 can determine, based in part on or according to the cosine similarity, whether the neural network model 220 was trained using a dataset 230 having a plurality of classes 232 of data 234 that includes a first class 232 of data 234 that incorporates the defined marker data 208. For example, the device 202 can use the cosine similarity score to determine if one or more characteristics 224 of the neural network 220 is similar to or matches one or more characteristics 210 of the defined marker 208. For example, the device 202 can determine the cosine similarity score between the classifier vector 226 of neural network 220 and the direction vector 228 of the defined marker 208 is greater than a determined threshold (e.g., cosine similarity threshold) and determine that the neural network 220 was trained using the defined marker data 208. In some embodiments, the device 202 can determine the cosine similarity score between the classifier vector 226 of neural network 220 and the direction vector 228 of the defined marker 208 is less than a determined threshold (e.g., cosine similarity threshold) and determine that the neural network 220 was not trained using the defined marker data 208.

The device 202 can use a plurality of p-values and/or a confidence score to determine if the neural network 220 was trained using the defined marker data 208. The device 202 can perform a plurality of tests, T₁-Tₖ, independent under a null hypothesis H₀ to determine if the neural network 220 was trained using the defined marker data 208. For example, under the null hypothesis H₀, the corresponding p-values, p₁-pₖ, can be distributed uniformly for a determined range [0, 1]. The device 202 can determine that log(pi) has an exponential distribution which corresponds to a x² distribution with two degrees of freedom. The quantity −2Σᵢ^{k} log(pi) thus follows a x² distribution with 2 k degrees of freedom. The device 202 can determine a combined p-value for the p values over the determined range. The combined p-value can correspond to a probability (e.g., confidence score) that the neural network 220 was trained using the defined marker data 208. For example, if the combined p-value (e.g., p-value of whole dataset 230) is less than a determined threshold (e.g., confidence threshold, p-value threshold), the device 202 can determine that the neural network 220 was trained using the defined marker data 208. In some embodiments, the device 202 can determine the combined p-value is greater than a determined threshold (e.g., confidence threshold, p-value threshold) and can determine that the neural network 220 was not trained using the defined marker data 208.

The device 202, at a detection time, can examine the classifier vector 226 of the neural network 220 (e.g., linear classifier of class w) to determine if the neural network 220 (e.g., class w) was trained using the marked data 234 (e.g., radioactive data) or unmarked data (e.g., vanilla data). For example, the device 202 can test the statistical hypothesis H₁: “class w was trained using marked data 234” against the null hypothesis H₀: “class w was trained using unmarked data 234.” Under the null hypothesis H₀, u (e.g., direction vector 228 of defined marker 208) is a random vector independent of w. The cosine similarity c(u,w) can follow the beta-incomplete distribution with parameters

$$a = \frac{d - 1}{2} and b = \frac{1}{2} .$$

In some embodiments, under hypothesis H₁, the device 202 can determine the classifier vector 226 w is more aligned with the direction vector 228 u so c(u, w) is likely to be higher and/or greater than a threshold value (e.g., cosine similarity threshold). At detection time, under the null hypothesis, the cosine similarities c(uᵢ, wᵢ) can be independent (e.g., since u₁ are independent) and the device 202 can combine the p-values for each call using a combined probability test (e.g., Fishers combine probability test) to determine the p-value for the whole dataset 230. The device 202 can take or perform a dot product (operation or calculation) between the classifier vector 226 and the direction vector 228 of the defined marker 208 to determine if the neural network 220 was trained using the defined marker data 208. For example, the device 202 can determine that the classifier vector 226 of the class w can have a positive dot product with the direction vector 228 “u” when the neural network 220 is trained using the defined marker data 208. The device 202 can determine that the classifier vector 226 of the class w can have a negative dot product with the direction vector 228 “u” when the neural network 220 is not trained using the defined marker data 208.

In some embodiments, the device 202 can determine that a value of (u, w) is high and/or greater than a first threshold (e.g., cosine similarity threshold) and that the combined p-value for dataset 230 (e.g., the probability of it happening under the null hypothesis H₀) is low or less than a second threshold (e.g., probability threshold). The device 202 can determine that the defined marker data 208 (e.g., radioactive data) has been used to train the neural network 220, responsive to the value of (u, w) being greater than the first threshold value and the p-value being less than a second threshold (e.g., probability threshold).

In some embodiments, the device can use the characteristics of the feature extractor of the classifier vector 226 to determine if the neural network 220 was trained using the defined marker data 208. For example, the device 202 can perform a white-box test with subspace alignment and the white-box test can refer to or include using weights or characteristics of the neural network 22o to determine if the neural network 220 was trained using the defined marker data 208. The device 202, during the detection stage, can align the subspaces of the feature extractors to address that the output spaces ϕ₀ and ϕₜ may not correspond to each other. The device 202 can generate a linear mapping M∈ [symbol] ^{d×d} such that ϕₜ(x)≈Mϕ₀(x). The linear mapping can be estimated by L₂ regression:

$${min}_{M} {𝔼}_{x} [ {‖ {ϕ}_{t} ( x ) - M {ϕ}_{o} ( x ) ‖}_{2}^{2} ] \qquad ( 14 )$$

In some embodiments, the device 202 can use the unmarked data 234 (e.g., vanilla data) of an unused or held out dataset 230 (e.g., validation set) to perform an estimation. The device 202 can modify or manipulate the classifier vector 226 to be represented by the following: Wϕₜ(x)≈WMϕ₀(x). The lines of WM can form classification vectors aligned with the output space of ϕ₀, and the device 202 can compare the vectors to the direction vector 228 (e.g., uᵢ) in cosine similarity. Under the null hypothesis, uᵢ can include random vectors independent of ϕ₀, ϕₜ, W and M and therefore the cosine similarity is provided by the beta incomplete function and the device 202 can determine the cosine similarity to determine if the neural network 220 was trained using the defined marker data 208.

In some embodiments, the classifier 226 can learn on the marked data 234 (e.g., radioactive dataset) and can be related to (1) a classifier 226 learned on or using unmarked data 234 (e.g., unmarked images) and (2) the direction vector 228 (e.g., direction of the carrier) of the defined marker data 208. For example, the data 234 can be marked in the latent feature space prior to or just before the classification layer and the device 202 can determine or assume that the logistic regression has been re-trained. For a given class 232, the device 202 can determine how or whether the classifier vector 226 learned with the defined marker 208 using characteristics of the classifier vector 226, the direction vector 228, and/or characteristics of a noise space, [symbol] . The classifier vector 226 can learn or train using unmarked data 234 corresponding to a “semantic” space. The semantic space can include a one dimensional subspace identified by a vector w*. The direction vector 228 can be represented by a vector u. In some embodiments, the direction vector can favor or support the insertion of the class-specific defined marker 208. The noise space, [symbol] , can correspond to the supplementary subspace to the span of the vectors w* and u of the previous space. In some embodiments, this span can be due to the randomness of the initialization and the optimization procedure (e.g., SGD, random data augmentations). The device 202 can perform this decomposition to quantify, with respect to the norm of the vector, what is the dominant subspace depending on the fraction of the marked data 234. The device 202 can determine that the two dimensional subspace contains a large portion or most of the projection of the new vector, which can be determined or seen by the fact that the norm of the vector projected onto that subspace is close to or within a defined range of a value of 1. In some embodiments, the contribution of the semantic vector can be significant and still dominant compared to the defined marker 208, for example, even when a large portion of the dataset 230 is marked. In some embodiments, the device 202 can generate histograms of cosine similarities between the classifier vector 226, direction vector 228 (e.g., random direction vectors), the mark direction and the semantic direction. The device 202 can determine, using the histograms, that the classifier vector 226 can align with or is aligned with the defined marker 208 when the q=20% (e.g., percentage, portion) of the dataset 230 is marked and/or when q=2% (e.g., percentage, portion) of the dataset 230 is marked.

Referring to 320, and in some embodiments, a determination can be made that the neural network was trained using the defined marker data. The device 202 can determine that the defined marker data 208 or marked data 234 was provided to the neural network 220 and the neural network 220 processed the defined marker data 208 (e.g., during training). In some embodiments, in response to one or more characteristics 224 of the neural network 220 matching or aligning with one or more characteristics 210 of the defined marker data 208, the device 202 can determine that the neural network 220 processed (or is trained using) the defined marker data 208.

The device 202 can determine the neural network 220 was trained using the marked data 234 for different types of data augmentation (e.g., center crop, random crop) using one or more characteristics of the neural network 220. For example, the device 202 can determine that the neural network 220 was trained using the marked data 234 using the p-values, when the p-values are lower or less than a threshold value. The device 202 can determine that the neural network 220 was trained using the marked data when a portion, percentage or fraction of the total dataset 230 is marked. In some embodiments, the device 202 can determine that the neural network 220 was trained using the marked data when q=1% of the dataset 230 is marked, q=20% of the dataset 230 is marked or a percentage less than 100% of the dataset 230 is marked.

In some embodiments, the device 202 can generate and/or provide an indication to an originator of the respective data 234 and/or dataset 230, indicating that the originator's data 234 and/or dataset 230 was used to train the neural network 220. For example, the device 202 can provide the indication to at least one device (e.g., computing device) associated with the originator and/or a device the respective data 234 and/or dataset 230 was received from, indicating that the originator's data 234 and/or dataset 230 was used to train the neural network 220. Thus, the originator of the data 234 and/or dataset 230 can control or be alerted to downstream use of the originator's respective data.

Referring to 322, and in some embodiments, a determination can be made that the neural network was not trained using the defined marker data. The device 202 can determine that the defined marker data 208 or marked data 234 was not provided to the neural network 220. For example, the device 202 can determine that the neural network was provided unmarked data 234 (e.g., vanilla data) or data 234 marked with a different mark 208 from the defined marker 208 (e.g., data provided by a different originator).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
determining, by at least one processor, characteristics of a neural network model;
comparing, by the at least one processor, the characteristics of the neural network model with characteristics of a defined marker data incorporated into a first class of data; and
determining, by the at least one processor responsive to the comparing, whether the neural network model was trained using a dataset having a plurality of classes of data that includes the first class of data incorporated with the defined marker data.

2. The method of claim 1, further comprising incorporating the defined marker data into data of the first class of data.

3. The method of claim 1, wherein the characteristics of the neural network model comprises a classifier vector of the neural network model, and the characteristics of the defined marker data comprises a direction vector of the defined marker data.

4. The method of claim 3, wherein the comparing comprises determining a cosine similarity between the classifier vector and the direction vector.

5. The method of claim 1, wherein the characteristics of the neural network model comprises a first loss value from applying first data without the defined marker data to the neural network model, and the characteristics of the defined marker data comprises a second loss value from applying second data incorporated with the defined marker data to the neural network model.

6. The method of claim 5, comprising determining, responsive to the first loss value being higher than the second loss value, that the neural network model was trained using the dataset having the plurality of classes of data that includes the first class of data incorporated with the defined marker data.

7. The method of claim 1, wherein the defined marker data includes a random isotropic unit vector applied to data in the first class of data.

8. The method of claim 1, wherein the dataset includes at least one of image data, audio data or video data.

9. The method of claim 1, wherein the first class of data includes a continuous signal.

10. A method comprising:
determining a classifier vector of a neural network model;
determining a cosine similarity between the classifier vector and a direction vector of a defined marker data; and
determining, according to the cosine similarity, whether the neural network model was trained using a dataset having a plurality of classes of data that includes a first class of data that incorporates the defined marker data.

11. The method of claim 10, further comprising:
determining a first loss value for the neural network from applying first data without the defined marker data to the neural network model; and
determining a second loss value for the defined marker from applying second data incorporated with the defined marker data to the neural network model.

12. The method of claim 11, further comprising:
determining, responsive to the first loss value being higher than the second loss value, that the neural network model was trained using the dataset having the plurality of classes of data that includes the first class of data incorporated with the defined marker data.

13. The method of claim 10, wherein the defined marker data includes a random isotropic unit vector applied to data in the first class of data.

14. A device comprising:
at least one processor configured to:
determine characteristics of a neural network model;
compare the characteristics of the neural network model with characteristics of a defined marker data incorporated into a first class of data; and
determine, responsive to the comparing, whether the neural network model was trained using a dataset having a plurality of classes of data that includes the first class of data incorporated with the defined marker data.

15. The device of claim 14, wherein the at least one processor is further configured to:
incorporate the defined marker data into data of the first class of data.

16. The device of claim 14, wherein the characteristics of the neural network model comprises a classifier vector of the neural network model, and the characteristics of the defined marker data comprises a direction vector of the defined marker data.

17. The device of claim 14, wherein the at least one processor is further configured to:
determine a cosine similarity between the classifier vector and the direction vector.

18. The device of claim 14, wherein the characteristics of the neural network model comprises a first loss value from applying first data without the defined marker data to the neural network model, and the characteristics of the defined marker data comprises a second loss value from applying second data incorporated with the defined marker data to the neural network model.

19. The device of claim 18, wherein the at least one processor is further configured to:
determine, responsive to the first loss value being higher than the second loss value, that the neural network model was trained using the dataset having the plurality of classes of data that includes the first class of data incorporated with the defined marker data.

20. The device of claim 14, wherein the defined marker data includes a random isotropic unit vector applied to data in the first class of data.
